(19) United States
(12) Patent Application Publication
(10) Pub. No.: US 2017/0122014 A1
(43) Pub. Date: May 4, 2017

(54) Latching Arrangement

(71) Applicant: Hoffman Enclosures, Inc., Anoka, MN (US)

(72) Inventors: Csaba Andrasfi, St. Paul, MN (US); Nathan L. Westby, Zimmerman, MN (US)

(21) Appl. No.: 15/341,986

(22) Filed: Nov. 2, 2016

Related U.S. Application Data
(60) Provisional application No. 62/249,829, filed on Nov. 2, 2015.

(51) Int. Cl. E05C 9/02; E05B 1/00; E05B 65/02; E05B 17/00; E05B 15/02

(52) U.S. Cl. CPC E05C 9/021; E05B 17/007; E05B 15/0205; E05B 17/0025; E05B 65/02; E05B 1/0092

(57) ABSTRACT

Embodiments of the invention provide a latching arrangement for an enclosure with an enclosure door and an enclosure body. First and second latch members are secured at first and second latch-member locations, respectively, relative to the enclosure door. First and second catch members are secured at first and second catch-member locations relative to the enclosure body. When a handle of the door is moved from a first handle orientation towards a second handle orientation, the first latch member engages the first catch member before the second latch member engages the second catch member.

### RELATED APPLICATIONS

This application claims priority to U.S. Provisional Patent Application No. 62/249,829, which was filed Nov. 2, 2015.

### BACKGROUND

Enclosures for electrical and other equipment can include doors that open and close to allow and prevent access, respectively, to the interiors of the enclosures and thereby help to protect components within the enclosures. In some cases, latching arrangements can be configured for use with (e.g., attached to) such doors, in order to help secure the doors in respective closed orientations. Conventional latching arrangements for enclosures can include multiple latch points, which are configured to substantially simultaneously engage corresponding catch points in order to secure the doors in the closed orientations.

In some settings, doors for enclosures can warp, bow, sag, or otherwise become deformed from a desired shape or orientation. This can interfere with the operation of conventional latching arrangements. For example, sufficient warping of a door can move latches on the door out of alignment with corresponding catches on the relevant enclosure. Accordingly, a user may be required to physically engage (e.g., manually push) the door at different locations in order to force the latches back into alignment and thereby allow the door to be securely latched closed. For example, as the user pushes the door closed using a contact point at or near a handle, the user may also need to simultaneously engage (e.g., push) the top or bottom of the door (e.g., with her hands or feet, respectively), in order to ensure that each of multiple latches engages a corresponding catch.

### SUMMARY

Some embodiments of the invention provide an electrical enclosure with an enclosure body configured to house electrical components, and an enclosure door configured to pivot, relative to the enclosure body, between an open orientation and a closed orientation. A handle can be configured to move between a first handle orientation and a second handle orientation. A first latch member and a second latch member can be supported by the enclosure door. A first catch member can be secured to the enclosure body and can be configured to engage the first latch member to secure the enclosure door in the closed orientation. A second catch member can be secured to the enclosure body and can be configured to engage the second latch member to secure the enclosure door in the closed orientation. As the handle is moved from the first handle orientation towards the second handle orientation, the first latch member can engage the first catch member before the second latch member engages the second catch member.

Some embodiments of the invention provide a latching arrangement for an electrical enclosure that includes an enclosure body configured to house electrical components, an enclosure door configured to move relative to the enclosure body between open and closed orientations, a handle configured to move between first and second handle orientations, and a latch rod configured to move relative to the enclosure door, between first and second latch-rod orientations, as the handle is moved between the first and second handle orientations, the electrical enclosure being configured to contain electrical components. A first latch member can be secured at a first latch-member location relative to the latch rod, and a second latch member can be secured at a second latch-member location relative to the latch rod. A first catch member can be secured at a first catch-member location relative to the enclosure body and can be configured to engage the first latch member to secure the enclosure door in the closed orientation. A second catch member can be secured at a second catch-member location relative to the enclosure body, and can be configured to engage the second latch member to secure the enclosure door in the closed orientation. As the handle is moved from the first handle orientation towards the second handle orientation, the first latch member can engage the first catch member before the second latch member engages the second catch member.

Some embodiments of the invention provide a method of latching an electrical enclosure that includes an enclosure body, an enclosure door configured to pivot between open and closed orientations, a handle supported by the enclosure door, a first latch member supported by the enclosure door, a second latch member supported by the enclosure door, a first catch member secured to the enclosure body, and a second catch member secured to the enclosure body. The enclosure door can be moved from an open orientation towards a closed orientation. The handle can be moved to cause the first latch member and the second latch member to translate relative to the enclosure door. As the handle is moved, the first latch member can engage the first latch member before the second catch member engages the second latch member.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a right, rear, top perspective view of part of a latching arrangement according to one embodiment of the invention, with the latching arrangement installed on an enclosure and an associated enclosure door, and with a left side panel of the enclosure removed to show the latching arrangement;

FIG. 2 is an exploded left, front, top perspective view of a latch rod, a latching member and a rack for the latching arrangement of FIG. 1;

FIG. 3A is a right side elevation view of the latching arrangement, the enclosure, and the enclosure door of FIG. 1, with the left side panel of the enclosure removed, with the latching arrangement in a first state, and with enlarged views of areas A, B, and C;

FIG. 3B is a similar view to FIG. 3A, including enlarged views of the areas A, B, and C, with the latching arrangement in a second state;

FIG. 3C is a similar view to FIGS. 3A and 3B, including enlarged views of the areas A, B, and C, with the latching arrangement in a third state;

FIG. 4A is a right, front, top perspective view of a handle assembly for use with the latching arrangement of FIG. 1, with the handle assembly in a first state;

FIG. 4B is a similar view to FIG. 4A, with the handle assembly in a second state;

FIG. 4C is a partial front elevational view of the handle assembly of FIG. 4A, with the handle assembly in the first state and rendered partially transparently;

FIGS. 5A and 5B are front elevational views of a rack arrangement for the latching arrangement of FIG. 1, for use with the handle assembly of FIG. 4A, with the rack arrangement in first and second states, respectively, corresponding the first and second states of the handle assembly of FIGS. 4A and 4B;

FIG. 6A is a right, front, top perspective view of another handle assembly for use with the latching arrangement of FIG. 1, with the handle assembly in a first state;

FIG. 6B is a similar view to FIG. 6A, with the handle assembly in a second state;

FIG. 6C is a partial front elevational view of the handle assembly of FIG. 6A, with the handle assembly in the first state and rendered partly transparently; and

FIGS. 7A and 7B are front elevational views of another rack arrangement for the latching arrangement of FIG. 1, for use with the handle assembly of FIG. 6A, with the rack arrangement in first and second states, respectively, corresponding the first and second states of the handle assembly of FIGS. 6A and 6B.

### DETAILED DESCRIPTION

Before any embodiments of the invention are explained in detail, it is to be understood that the invention is not limited in its application to the details of construction and the arrangement of components set forth in the following description or illustrated in the following, drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Likewise, the phrases “at least one of A, B, and C,” “one or more of A, B, and C,” and the like, are meant to indicate A, or B, or C, or any combination of A, B, and/or C. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As used herein, the term “enclosure” indicates a structure, other than a building, that is configured to enclose one or more components. For example, the term “electrical enclosure” generally indicates a box-like structure (e.g., formed mainly from sheet metal) that is configured to enclose and protect electrical components such as power electronics or other power management equipment, network or other computing equipment, and so on.

Generally, it may be useful to allow users to securely latch doors for enclosures (e.g., electrical enclosures) in closed orientations. Indeed, for some installations, a securely closed door can be essential in obtaining appropriate sealing of a door opening. Such sealing may be necessary, for example, to prevent water, gas or other substances from moving into or out of an enclosure or to otherwise protect electrical (or other) components within the enclosure.

As noted above, however, doors for enclosures can sometimes warp, bow, sag, or otherwise become deformed, which can inhibit effective closing and sealing of the doors. In some cases, this may be a particular concern for electrical enclosures. For example, some electrical enclosures may have relatively large (e.g., 100 inches tall) sheet metal doors that themselves support relatively heavy electrical (or other) components such as air conditioners, heat exchangers, or control panels. As a result, doors of electrical enclosures can sometimes be subject to significant warping or other deformation, which can inhibit effective closing of the doors and thereby, effective protection of enclosed electrical components.

With various enclosure doors, including doors for electrical enclosures, it may be useful to provide multiple latch points (e.g., multiple pairs of latches and catches), in order to ensure that the doors can be securely closed and latched. However, in conventional designs, it can be difficult to cause multiple latch points to appropriately engage. This may be particularly true, for example, when doors have become deformed (e.g., due to thermal effects or forces from attached electrical components). For example, for deformed enclosure doors with conventional multi-point latching arrangements, users may be required to physically force the doors back into relatively un-deformed shape (or otherwise force the doors into alignment with the relevant door openings) while simultaneously trying to activate relevant latching mechanisms. This can be difficult, particularly for larger (e.g., relatively tall) or more heavily loaded doors, potentially resulting in lost time, user strain, and, in some cases, improperly closed or sealed doors.

In some cases, deformation (e.g., warping) or other effects that hinder easy latching can be particularly problematic for doors of enclosures (e.g., electrical enclosures), as compared to other types of installations. For example, in contrast to other potentially more consistently and securely framed arrangements (e.g., windows or doors of buildings, which are often framed within significantly rigid surrounding structures), doors for enclosures can be relatively free-floating. In this regard, particularly for doors formed from sheet metal or other similar materials, structures that support the doors (e.g., frame members of the relevant enclosure bodies) may provide relatively little resistance to deformation of the doors. Moreover, installation environments for enclosures (e.g., as compared to buildings or other more permanent structures) can sometimes also contribute to relatively substantial deformation of enclosure doors. For example, electrical enclosures are sometimes installed on non-level surfaces, which can further contribute to deformation of the enclosure doors.

These issues, and others, can be addressed by embodiments of the latching arrangement (and associated method) disclosed herein. For example, in some embodiments, multiple latch points can be provided for an enclosure door, with each latch point including a latch (e.g., a latch member secured to the door) and a corresponding catch (e.g., a catch member secured to the enclosure body). Generally, the latches of the multiple latch points can be configured to be moved in unison relative to a door, via a single user-initiated action, while the catches can be configured to remain stationary relative to the enclosure body.

In order to provide an offset timing to the engagement of different latch points, particular latches can be separated from each other with a different spacing than is used to separate the associated catches. For example, a spacing between a central latch and either of two peripheral latches can be somewhat larger than a spacing between a central catch and either of two peripheral catches. Accordingly, as the latches are moved (e.g., via operation of a single handle mechanism), a first set of latches (e.g., the central latch) can be caused to engage the corresponding set of catches (e.g., the central catch) before another set (or sets) of latches engages the corresponding set (or sets) of catches. As such, for example, the first (and first-engaging) set of latches can help to pull the door into appropriate alignment, at least partly counteracting warping of the door, so that the subsequently-engaging latches can more easily and reliably engage the corresponding catches.

In some embodiments, a first-engaging latch can be disposed in alignment with a handle mechanism on the relevant enclosure door. For example, a central latch disposed at the same height as a handle mechanism, but on an opposite side of the door from the handle mechanism (e.g., inside the door, as opposed to outside) can be configured to engage a corresponding catch (e.g., a catch attached to an enclosure body) before other latches engage their corresponding catches. In this way, for example, a user can be enabled use a single application of force (e.g., a pushing force on the handle mechanism) to move the door closed, to align the first-engaging latch with its catch, and to activate the handle mechanism to cause the latch to engage the catch. In some cases, this can help users to avoid the need to push on the handle with one hand while simultaneously bearing on another part of the door (e.g., a top corner of the door) with another. Further, in some cases where the door has been deformed, the configuration of a latching arrangement to generally align a user-applied closing force for the door (e.g., as applied by the user against a handle mechanism) with a first-engaging latch and a corresponding catch can result in the user-applied force urging the latch into alignment (and engagement) with the catch while also simultaneously correcting for the deformation of the door.

In some cases, it may be particularly useful to align a handle mechanism and a first-engaging latch at a substantially central location on an enclosure door. For example, the effects of deformation (e.g., warping) of enclosure doors can sometimes be more substantial near one or more of the corners of the door than near a central location on the door. Accordingly, a latch that is centrally located on an enclosure door (e.g., centrally located with respect to a vertical direction) may be somewhat less displaced from a desired latching orientation by deformation of the door than more peripherally located (e.g., top and bottom) latches. Therefore, on a deformed enclosure door, a user may be able to cause a central latch to engage a corresponding catch with relative ease, particularly when the user, in order to close the door and activate the latch, is able to engage (e.g., push on) a handle mechanism that is generally in alignment with the latch. The resulting engagement of the central latch with the catch can then pull the door into generally better alignment with the door opening of the enclosure, thereby generally urging the door closer to its un-deformed state and generally aligning other latches for engagement with the corresponding catches. Further, with a central latch engaged with a catch, a user may be free to use one hand to continue to activate a handle mechanism using relatively little force (e.g., to engage additional latch points), while using another hand to apply relatively substantial closing (or other) force to an upper or lower region of the door (e.g., where deformation of the door may be more pronounced).

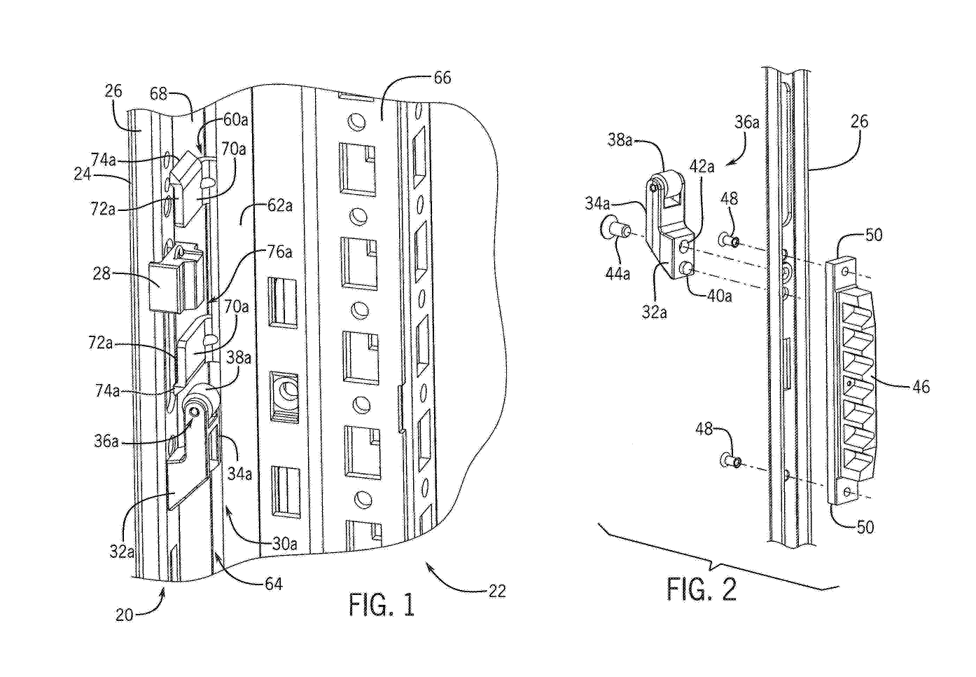

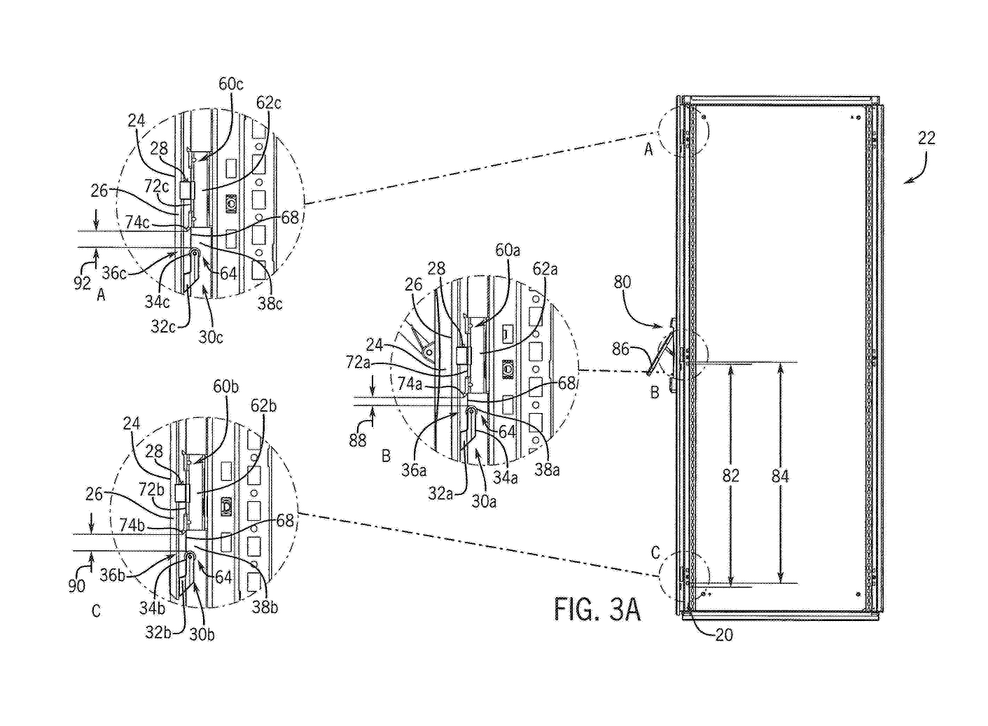

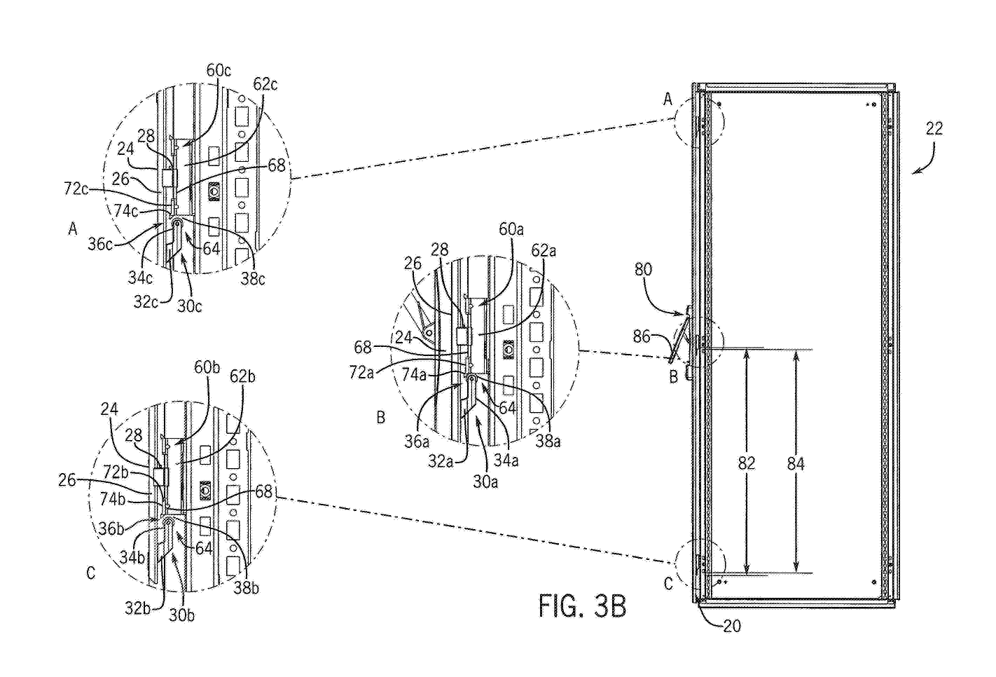

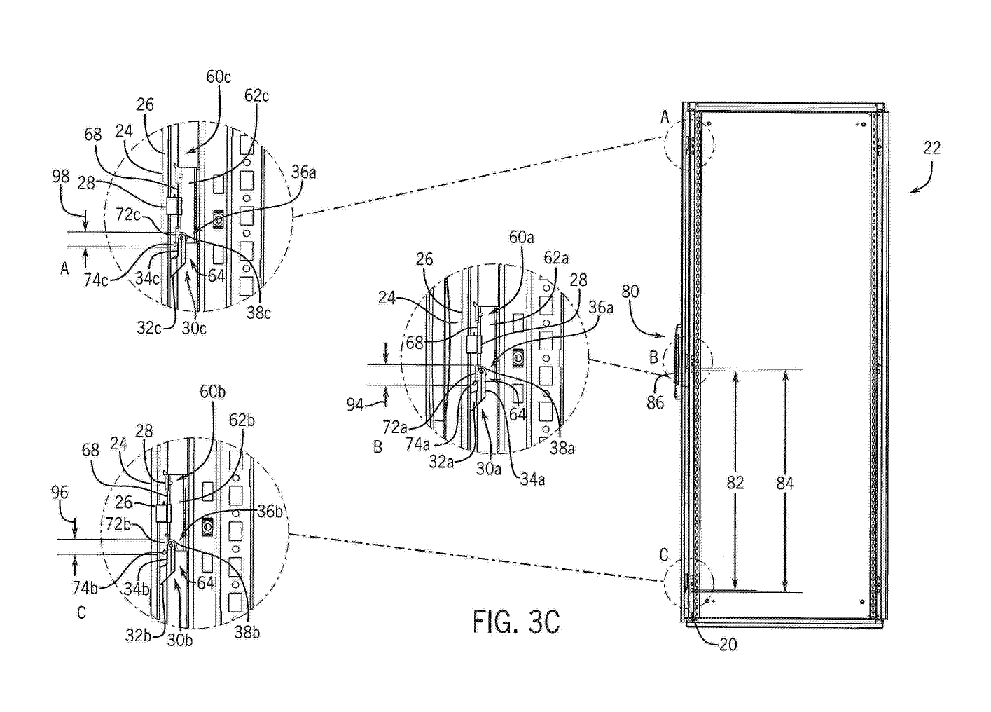

FIG. 1 illustrates select components of a latching arrangement 20 according to one embodiment of this disclosure. The latching arrangement 20, as illustrated, is installed for use with an enclosure 22 having a door 24 (see also, e.g., FIGS. 3A through 3C) configured to move relative to a body of the enclosure 22. In some embodiments, the enclosure 22 can be an electrical enclosure, configured to house network equipment or other components of electrical systems. In some embodiments, the latching arrangement 20, or other latching arrangements according to this disclosure, can be used in other settings, including with other enclosures.

In the embodiment illustrated in FIG. 1, the latching arrangement 20 includes a latch rod 26 slidably secured to an interior side of the door 24 with a retainer 28. The latch rod 26 is illustrated as extending substantially vertically along an outer edge of the door 24. In other embodiments, a latch rod can be secured to a door in other orientations, at other locations, or in other ways.

Generally, multiple latches (and latch members) can be secured to a latch rod in order to help secure a door in a closed orientation. In the latching arrangement 20, three latches with corresponding latch members 30 are used, with each of the latch members 30 configured similarly to each other, and with each of the latch members 30 disposed at a unique position on the latch rod 26. To facilitate general discussion herein, while also distinguishing the various latch members 30 and components thereof from each other, letter designators will be appended to the relevant reference numerals in discussion below. For example, the latch member 30 illustrated in FIG. 1 is designated as a latch member 30a. Additional, similar latch members 30b and 30c, as well as the latch member 30a, are illustrated in FIGS. 3A through 3C. Reference to the latch members 30 or to components thereof without use of alphabetic designators should be understood to generally include each of the latch members 30 or relevant components thereof.

In some embodiments, latches (and latch members) of different designs can be used in the same latching arrangement. For example, in some embodiments, a centrally located latch can be configured different from one or more peripheral latches. As such, it will be understood that the similarity of the latch members 30a through 30c (i.e., the general uniformity of the latch members 30, collectively) is not intended to limit the disclosure to latching arrangements with substantially similar latch members. It will also be understood that the use of the three latch members 30a through 30c is presented as an example only, and that other embodiments can include different numbers of latch members.

In the embodiment illustrated, each of the latch members 30 is substantially identical to the others, with a generally triangular base 32 (e.g., a base 32a in FIG. 1), and with an elongate latch finger 34 (e.g., a latch finger 34a in FIG. 1) extending away from the base 32. Each of the latch fingers 34 extends away from the corresponding base 32 in a direction that is substantially parallel with the latch rod 26 and the door 24, so that a generally u-shaped recess is formed between each of the latch fingers 34 and the latch rod 26. In other embodiments, other configurations are possible.

In some embodiments, latches can include movable elements, which can, for example, help the latches engage corresponding catches relatively smoothly. In the embodiment illustrated, a free end 36 (e.g., a free end 36a in FIG. 1) of each latch finger 34 supports a rolling element configured as a wheel 38 (e.g., a wheel 38a in FIG. 1). In other embodiments, other configurations are possible. For example, a latch member such as the latch member 30 can include features such as composite wedges, or other structures, as an alternative (or in addition) to a rolling element such as the wheel 38.

Generally, latches (or components thereof) can be secured to the latch rod at respective latch-member locations in various ways. As illustrated in FIG. 2, for example, the base 32a of the latch member 30a includes a locating feature configured as a post 40a, as well as a mounting aperture configured as a round hole 42a. To secure the latch member 30a to the latch rod 26, the post 40 can be seated in a corresponding locating aperture on the latch rod 26, and a fastener 44a can be extended through both the hole 42a and a corresponding mounting aperture on the latch rod 26. The latch members 30b and 30c (see, e.g., FIGS. 3A through 3C), or other latch members, can be similarly secured to the latch rod 26 at respective latch-member locations.

In some embodiments, a gear or rack arrangement can be included as part of a latching arrangement in order to translate user input (e.g., actuation of a handle mechanism) into appropriate latching or unlatching movements for the latching arrangement as a whole. As also illustrated in FIG. 2, a rack 46 for moving the latch rod 26, and the various latch members 30, can be secured to the latch rod 26 for this purpose. In the embodiment illustrated, the rack 45 is secured to the latch rod 26 by extending fasteners 48 through the latch rod 26 to engage mounting apertures on two mounting flanges 50 of the rack 46. Additional aspects of the rack 46, including the role of the rack 46 in operating the illustrated latching arrangement, are also discussed below.

Generally, a latching arrangement according to the invention can also include multiple catches, with each catch configured to engage with a corresponding latch to help secure a door in a closed orientation. Referring again to FIG. 1 and also to FIGS. 3A through 3C, for example, the latching arrangement 20 includes multiple catch members 60, which are secured to the enclosure 22 and generally configured to engage latch members 30 to secure the door 24 in a closed orientation relative to the enclosure 22. In the latching arrangement 20, three catch members 60 are used, corresponding to the three latch members 30. Like the three latch members 30, the three catch members 60 are configured similarly to each other, and are disposed at a unique position on the enclosure 22. In some embodiments, one or more of the catches (or catch members) can be configured differently, or a different number of catches can be used.

To facilitate general discussion herein, while also distinguishing the various catch members 60 and components thereof from each other, letter designators will be appended to the relevant reference numerals in discussion below. For example, the catch member 60 illustrated in FIG. 1 is a catch member 60a. Additional catch members 60b and 60c, as well as the catch member 60a, are illustrated in FIGS. 3A through 3C. Reference to the catch members 60, and components thereof, without use of alphabetic designators, will be understood to generally include each of the catch members 60, and associated components.

In the embodiment illustrated, each of the catch members 60 (including the catch member 60a illustrated in FIG. 1) includes a bracket with a body portion 62 (e.g., a body portion 62a in FIG. 1) that is secured to the enclosure 22. The catch members 60 can generally be secured to the enclosure 22 (e.g., to a frame member of the enclosure 22) in various ways. AS illustrated, for example, the catch members 60 are secured to the enclosure 22 within a channel 64 defined by a front frame member 66 and an outer flange 68 of the body of the enclosure 22. The body portions 62 can generally be secured within the channel 64 in various ways, including, for example, via fasteners of various kinds (e.g., screws, cage nut assemblies, and so on).

To engage with the corresponding latch members 30, sets of catch arms 70 (e.g., catch arms 70a in FIG. 1) are connected to (e.g., integrally formed with) the respective body portions 62 of the catch members 60, with outer ends 72 of the catch arms 70 (e.g., outer ends 72a in FIG. 1) extending laterally beyond the outer edge of the flange 68. In this way, for example, one or more of the outer ends 72 of each of the catch arms 70 can be available for engagement with the corresponding latch member 30, as the latch member 30 is moved along the outside of the channel 64 (e.g., along the edge of the flange 68). In some embodiments, ramps 74 (e.g., ramps 74a in FIG. 1) can be provided at the axial ends of the catch arms 70, relative to the orientation of the frame member 66 and the general direction of motion of the latch rod 26 (as also discussed below).

In some embodiments, catches can be configured with recesses or other open spaces to accommodate other components of a latching arrangement or of an enclosure in general. For example, the catch arms 70 of the catch members 60 are separated by a gap 76 (e.g., a gap 76a in FIG. 1) that extends between the catch arms 70 along the body portions 62 of the catch members 60. This may be useful, for example, in order to accommodate movement of the retainer 28 (or other feature) between the relevant catch arms 70.

In the embodiment illustrated, two catch arms 70 are provided for each catch member 60 (e.g., two catch arms 70a for the catch member 60a). This can be useful, for example, in order to allow the latch members 30 to engage the corresponding catch members 60 at either axial end of the catch members 60. This, in turn, may allow a user to configure the latching arrangement 20 to latch and unlatch the door 24 either by moving the latch rod 26 up and down, respectively, or by a reversed arrangement (i.e., by moving the latch rod 26 down and up, respectively). In other embodiments, a different number or orientation of catch arms (or other corresponding features) can be used for a given catch member.

The latch members 30 can be disposed relative to the door 24 and the enclosure 22 in different ways. In the embodiment illustrated, the latch member 30a is configured as part of a centrally located latch point, with the latch member 30a being disposed centrally along the latch rod 26, at the interior of the door 24, and in substantial alignment with a handle assembly 80 of the door 24 (e.g., generally aligned, both horizontally and vertically, with the handle assembly 80). The latch members 30b and 30c, in contrast, are configured as parts of peripheral latch points, being also disposed on the latch rod 26 at the interior of the door 24, but spaced apart from the handle assembly 80 and from the latch member 30a.

Generally, latches (or relevant components thereof) are separated by particular spacings, which can control where a particular latch (or component thereof) will be located in relation to another latch (or component thereof). In some embodiments, as also discussed below, this spacing can be selected in order to control the timing with which each latch of a set engages a corresponding catch. In the embodiment illustrated, the latches exhibit a latch-member spacing 82 between the latch members 30a and 30b, as measured from the tips of the respective free ends 36a and 36b (e.g., at the wheels 38a and 38b), and a substantially similar latch-member spacing (not labeled) between the latch members 30a and 30c, as measured from the tips of the respective free ends 36a and 36c (e.g., at the wheels 38a and 38c). In other embodiments, different configurations are possible.

Catches (or relevant components thereof) are also generally separated by particular spacings, which can be controlled by the placement of the catches relative to a supporting structure (e.g., a relevant frame member) and which can also help to control the timing with which particular latches engage particular catches. For example, the catch member 60a is disposed on the frame member 66 of the enclosure 22 in substantial alignment with the handle assembly 80 (when the door 24 is closed), similarly to the latch member 30a. The catch members 60h and 60c are also disposed on the frame member 66, but are spaced apart from the handle assembly 80 (when the door 24 is closed), and from the catch member 60a. In this arrangement, in the embodiment illustrated, a catch-member spacing 84 between the catch members 60a and 60b is substantially the same as a catch-member spacing (not labeled) between the catch members 60a and 60e. In other embodiments, other arrangements of the catches, and other catch-member spacings are possible. For example, in some embodiments, the spacing between the catch members 60a and 60b can be different from the spacing between the catch members 60a and 60c.

In some embodiments, differences between latch spacings and catch spacings (or similar other spacings) can usefully help to determine a sequence (or “timing”) with which the latch members engage the corresponding catch members. For example, as can be seen in particular in FIG. 3C, the latch-member spacing 82 between the latch members 30a and 30b is somewhat larger than the catch-member spacing 84 between the catch members 60a and 60b. Likewise, the latch-member spacing (not labeled) between the latch members 30a and 30c is somewhat larger than the catch-member spacing (not labeled) between the catch members 60a and 60c. As also discussed below, this can result in a sequential engagement of the latch members 30 with the catch members 60 when the latching arrangement is actuated. In other embodiments, alternative (or additional) relationships between the various relevant spacings are possible.

In order to operate the latching arrangement 20 to latch the door 24 in the closed orientation, a user can first move the door to an orientation at which the free end 36 of at least one of the latch members 30 is disposed at least partly in alignment with the ramp 74 of the corresponding at least one catch member 60 (e.g., as illustrated for each of the latch members 30 and the catch members 60 in FIG. 3A). In some cases, the user can actively push on the door at or near the handle assembly 80 (or elsewhere), to maintain such an aligned orientation of the door 24 and such an alignment of the relevant latch members 30 with the corresponding catch members 60. This can be useful, for example, to compress a gasket (not shown), or to correct for a deformation of the door 24.

Once the door 24 is appropriately aligned, the user can then actuate a handle assembly to actuate the latch rod 26 and effect a latching of the door. For example, a user can pivot a handle 86 of the handle assembly 80 up and out, with respect to the door 24 in order to cause the latch rod 26, and thereby the latch members 30, to translate axially (i.e., vertically upward, as illustrated) along the interior of the door 24. As also discussed below, in other embodiments, other types of handles and handle-actuating movements are possible. Likewise, in some embodiments, a latch rod can be moved in a different manner to engage or disengage a latch (e.g., can be moved vertically downward to engage a latch).

As also noted above, the latch-member spacings (e.g., the spacing 82) of the latching arrangement 20 are somewhat larger than the catch-member spacings (e.g., the spacing 84) of the latching arrangement 20. Accordingly, with the door 24 appropriately positioned for latching (e.g., as described above), a spacing 88 between the free end 36a of the latch member 30a and a lower end of the ramp 74a of the catch member 60a is somewhat smaller than a spacing 90 between the free end 36b of the latch member 30b and a lower end of the ramp 74b of the catch member 60b. Likewise, the spacing 88 is smaller than a spacing 92 between the free end 36c of the latch member 30e and a lower end of the ramp 74c of the catch member 60c. As a result, as the pivoting of the handle 86 causes the latch rod 26 to move upwards, the wheel 38a (and the latch member 30a, generally) will tend to reach and engage the ramp 74a (and the catch member 60a, generally) before the wheel 38b, (and the latch member 30b, generally) reaches and engages the ramp 74b (and the catch member 60b, generally). Likewise, the wheel 38a will tend to reach and engage the ramp 74a before the wheel 38c reaches and engages the ramp 74c. This offset timing in the engagement of particular latch members 30 with the corresponding catch members 60 can be seen in particular in FIG. 3B, in which the wheel 38a has engaged the ramp 74a while the wheels 38b and 38c are still spaced apart from the ramps 74b and 74c, respectively.

Once the latch member 30a is initially engaged with the ramp 74a, continued pivoting of the handle 86 upward can cause continued, progressive engagement of the latch member 30a with the ramp 74a, and with the catch member 60a generally. This, in turn, can tend to pull the door closer to the frame member 66, and closer to the enclosure 22 generally. Where warping or other deformation has occurred, this can usefully counteract at least some of the deformation in order to align the still unengaged (or at least less engaged) latch members 30b and 30c with the corresponding catch members 60b and 60c, without the user having to bear excessively on the door 24 or a particular part thereof (e.g., at a top or bottom portion of the door 24).

As the handle 86 is pivoted still further, and as illustrated in FIG. 3C, the latch members 30b and 30c can initially, and then fully, engage the catch members 60b and 60c, so that the door 24 can be fully latched. In the fully latched configuration, due to the offset aspect of the latches 30 and catches 60 of the latching arrangement 20 (e.g., as described above), an extension distance 94 of the latch member 30a over the catch member 60a can be somewhat longer than extension distances 96 and 98 of the latch members 30b and 30c, respectively, over the catch members 60b and 60c, respectively. In this regard, for example, the length of the latch fingers 34 (or at least the central latch finger 34a) can be usefully sized to be somewhat longer than would be necessary for the latch fingers 34, when employed individually, to securely engage a catch. Likewise, the length of the catch arms 70 (or at least the central catch arms 70a) can be usefully sized to be somewhat longer than would be necessary for the catch arms 70, when used individually, to securely engage a latch.

In some embodiments, a desired latch (or other) spacing can be alternatively (or additionally) controlled by varying the length of relevant latch-point components. For example, a catch arm of one catch member of a latching arrangement can be formed to be somewhat longer than other catch arms of the latching arrangement, in order for that catch arm to engage a corresponding latch member first. Similarly, in some embodiments, one latch member of a latching arrangement can be formed to be somewhat longer than other latch members of the latching arrangement.

In the latching arrangement 20, the two peripheral latch members 30b and 30c engage the two peripheral catch members 60b and 60c, respectively, at substantially the same time (i.e., substantially simultaneously). In other embodiments, other configurations and timings are possible. For example, the latch members 30a, 30b, and 30c can be configured to engage the respective catch members 60a, 60b, and 60c in any desired sequence (i.e., with any desired timing). In some embodiments, latch timing can be implemented such that none of the latch members 30 initially engage a corresponding catch member simultaneously with any of the other latch members 30. Similarly, in some embodiments with four or more catch members and four or more latch members, multiple sets of the catch members can be configured (e.g., spaced along a latch rod) to engage corresponding latch members simultaneously or with any desired sequence or timing.

In some embodiments, it may be possible for a user to adjust the position of the latch members 30 on the latch rod 26 or the position of the catch members 60 on the enclosure 22. This may be useful, for example, in order to vary the timing with which different latch members 30 engage the corresponding catch members 60. For example, a user could start with the latching arrangement 20 configured for simultaneous engagement by all three of the latch members 30, then later adjust the positions of the latch members 30 or of the catch members 60, such that the latch members 30a, 30b, and 30e engage the catch members 60a, 60b, and 60c in sequential order.

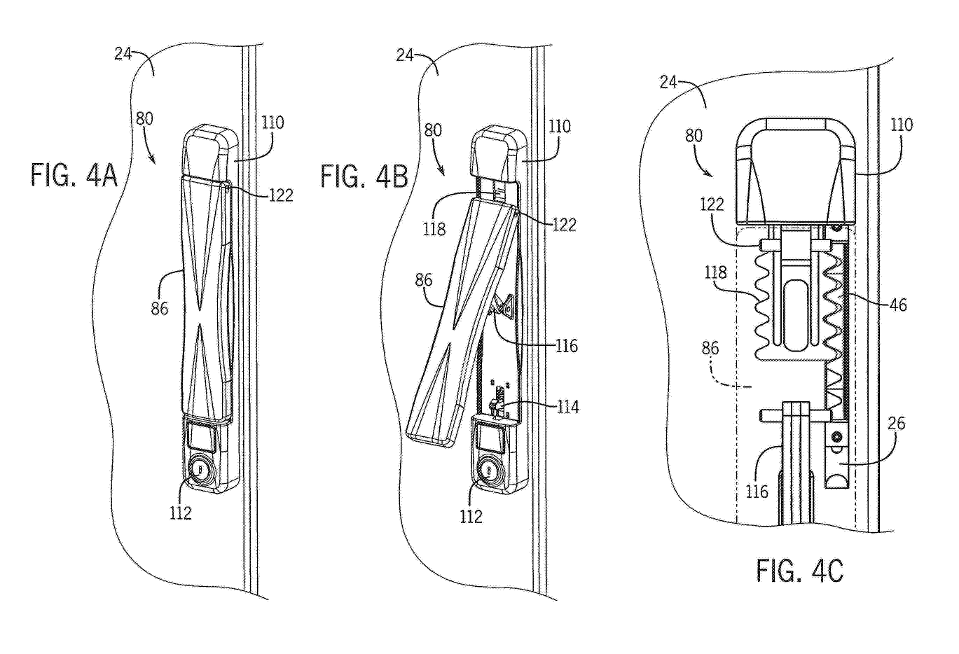

Generally, the disclosed latching arrangement can be configured for use with a handle of various types. For example, as illustrated in FIGS. 4A through 4C, the handle assembly 80 discussed above with regard to FIGS. 3A through 3C includes a handle base 110 supporting the handle 86. A lock 112 can also be included, in order to control whether a clasp 114 (see FIG. 4B) allows the handle 86 to move away from the base 110 and, thereby, whether a user can unlatch the door 24.

In the embodiment illustrated, the handle 86 is pivotally attached to the base 110 via a rigid link 116, and is slidably attached to the base 110 via a pivoting (e.g., pinned) connection 122 to a rack 118 that is in turn configured to slide within the base 110. With this arrangement, when the handle 86 is moved away from the base 110, the handle 86 pivots relative to the link 116 and the rack 118, the link 116 pivots relative to the base 110, and the rack 118 is thereby slid downwards within the base 110. Due to toothed engagement of the rack 118 with the rack 46 attached to the latch rod 26 (see also FIG. 2), moving the handle 86 away from the base 110 to move the rack 118 downward also moves the latch rod 26 axially downward, so that the latch members 30 can be disengaged from the catch members 60 (see also FIG. 3A) and the door 24 unlatched.

In a latching operation, the handle 86 and the latch rod 26 can then be moved in reverse from the process described above. For example, the handle can be pivoted towards the base 110 (e.g., from the orientation of FIG. 4B toward the orientation of FIG. 4A), thereby causing the rack 118 and the latch rod 26 to move correspondingly upwards. In this way, for example, the latch members 30 can be moved into engagement with the catch members 60 (see also FIG. 3C) and the door 24 latched closed

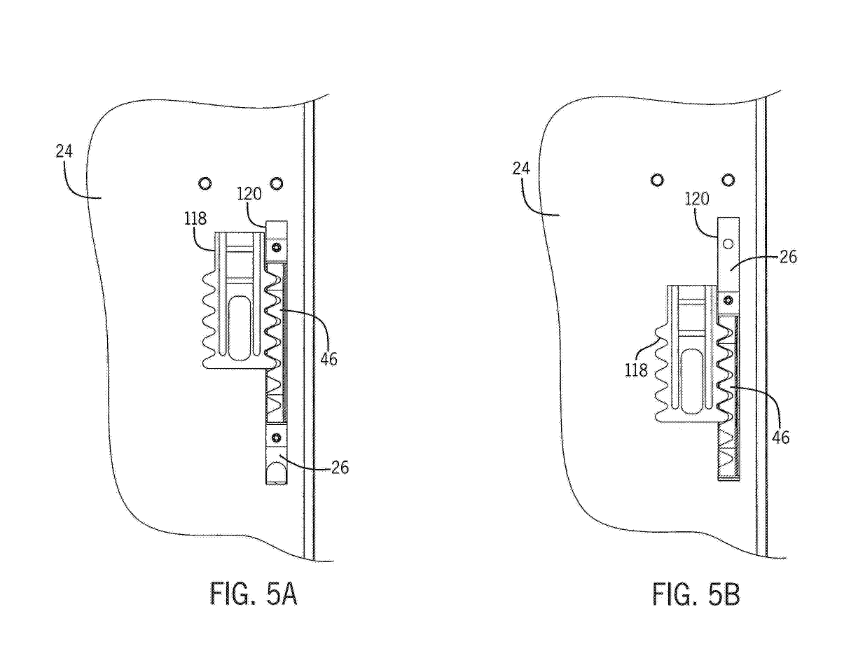

As illustrated in FIGS. 5A and 5B, in order to attach the handle assembly 80 to the latch rod 26, the door 24 is configured with a slot 120 through which the toothed portion of the rack 46 extends. In this way, for example, the latch rod 26 can be disposed on the interior of the door, and can still be actuated by the handle assembly 80, even though the handle assembly 80 is disposed on the exterior of the door. Generally, the slot 120 can be formed with sufficient length to allow the rack 46 to travel between a first orientation corresponding to full engagement of the latch members 30 with the catch members 60 (see FIGS. 3C and 5A) and a second orientation corresponding to full disengagement of the latch members 30 from the catch members 60 (see FIGS. 3A and 5B).

It will be understood that the orientations, mechanical arrangements, and particular operations illustrated in the various figures, including those discussed above, are presented as examples only. For example, some embodiments can include a latch rod configured to translate, rotate, or otherwise move in a different way than the latch rod 26. Similarly, some embodiments can include a handle assembly that operates in a different way than the handle assembly 80.

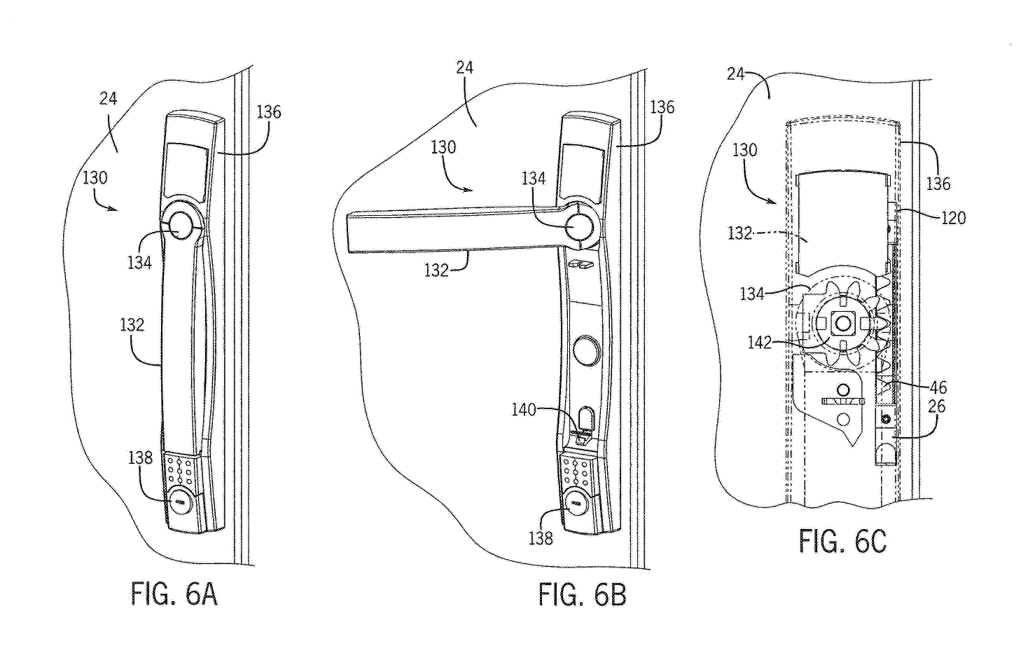

As illustrated in FIGS. 6A through 6C, another handle assembly 130 includes a handle 132 attached at a connection point 134 to a handle-assembly base 136. The base 136 also supports a lock 138, which controls a clasp 140 in order to secure the handle 132 against (or release the handle 132 for) use.

In contrast to the handle 86, the handle 132 is configured to pivot about a generally horizontal axis that extends through the connection point 134. Further, the handle is attached to a rack gear 142, rather than a linear rack, with the rack gear 142 configured for toothed engagement with the rack 46 secured to the latch rod 26. Accordingly, when the handle 132 is rotated in a first direction relative to the base 136 (e.g., clockwise, as illustrated), the rack gear 142 is rotated in a similar direction and, due to toothed engagement of the rack gear 142 with the rack 46 (see also FIG. 2), the latch rod 26 is moved axially downward. In this way, for example, the handle assembly 130 can be used to disengage the latch members 30 from the catch members 60 (see also FIG. 3A) and thereby unlatch the door 24.

Similarly, when the handle 132 is rotated in a different direction relative to the base 136 (e.g., counter-clockwise, as illustrated), the rack gear 142 is rotated in a similar direction and the latch rod 26 is moved axially upwards. In this way, for example, the latch members 30 can be moved into engagement with the catch members 60 (see also FIG. 3C) and the door 24 can be latched closed.

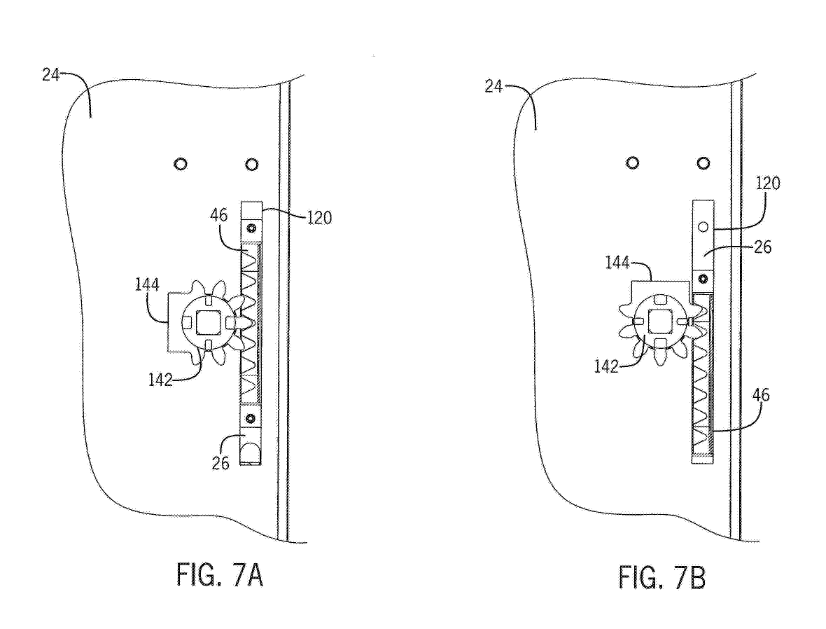

As illustrated in FIGS. 7A and 7B, the slot 120 of the door 24 can also allow the rack 46, as actuated by the rack gear 142, to travel between the orientation corresponding to full engagement of the latch members 30 with the catch members 60 (see FIGS. 3C and 6A) and the orientation corresponding to full disengagement of the latch members 30 with the catch members 60 (see FIGS. 3A and 6B). Further, as illustrated in FIG. 7B in particular, a boss feature 144 on the rack gear 142 can be configured contact the rack 46 to help prevent over-rotation of the handle 132 and corresponding over-actuation of the rack 46.

Thus, embodiments of the disclosed latching arrangement (e.g., the latching arrangements 20 and 152) can provide various benefits compared to conventional latching arrangements. In some embodiments, the disclosed latching arrangement can provide for offset timing between the engagement of different latch members with corresponding catch members. Accordingly, for example, one part of a door can be at least partly secured to an enclosure before a different part of the door. As also discussed above, this can help to alleviate issues with deformation of the door (e.g., due to warping), as well as providing various other benefits.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. An electrical enclosure comprising:
an enclosure body configured to house electrical components;
an enclosure door configured to pivot, relative to the enclosure body, between an open orientation and a closed orientation, the enclosure door being configured to protect the electrical components when in the closed orientation;
a handle configured to move between a first handle orientation and a second handle orientation;
a first latch member supported by the enclosure door;
a second latch member supported by the enclosure door;
a first catch member secured to the enclosure body, the first catch member being configured to engage the first latch member to secure the enclosure door in the closed orientation; and
a second catch member secured to the enclosure body, the second catch member being configured to engage the second latch member to secure the enclosure door in the closed orientation;
the first latch member, as the handle is moved from the first handle orientation towards the second handle orientation, engaging the first catch member before the second latch member engages the second catch member.

2. The electrical enclosure of claim 1, wherein the enclosure door is configured to support at least one of the electrical components.

3. The electrical enclosure of claim 1, further comprising:
a latch rod supported by, and configured to translate relative to, the enclosure door;
wherein the first latch member is secured to the latch rod at a first latch-member location on the latch rod; and
wherein a second latch member secured to the latch rod at a second latch-member location on the latch rod.

4. The electrical enclosure of claim 3, wherein the latch rod is configured to translate along the enclosure door in an axial direction as the handle is moved between the first and second handle orientations.

5. The electrical enclosure of claim 4, wherein a latch-member spacing between the first and second latch members on the latch rod is different from a catch-member spacing between the first and second catch members on the enclosure body, with the difference between the latch-member spacing and the catch-member spacing causing the first latch member to engage the first catch member before the second latch member engages the second catch member, as the handle is moved from the first handle orientation towards the second handle orientation.

6. The electrical enclosure of claim 1, wherein, as the handle is moved from the first handle orientation towards the second handle orientation, the first latch member engages the first catch member to urge the enclosure door towards the closed orientation before the second latch member engages the second catch member to urge the enclosure door towards the closed orientation.

7. A latching arrangement for an electrical enclosure that includes an enclosure body configured to house electrical components, an enclosure door configured to move relative to the enclosure body between open and closed orientations, a handle configured to move between first and second handle orientations, and a latch rod configured to move relative to the enclosure door, between first and second latch-rod orientations, as the handle is moved between the first and second handle orientations, the latching arrangement comprising:
a first latch member secured at a first latch-member location relative to the latch rod;
a second latch member secured at a second latch-member location relative to the latch rod;
a first catch member secured at a first catch-member location relative to the enclosure body, the first catch member being configured to engage the first latch member to secure the enclosure door in the closed orientation; and
a second catch member secured at a second catch-member location relative to the enclosure body, the second catch member being configured to engage the second latch member to secure the enclosure door in the closed orientation;
the first latch member being configured to engage the first catch member before the second latch member engages the second catch member, as the handle is moved from the first handle orientation towards the second handle orientation.

8. The latching arrangement of claim 7, wherein, as the handle is moved from the first handle orientation towards the second handle orientation, the first latch member engages the first catch member to urge the enclosure door towards the closed orientation before the second latch member contacts the second catch member.

9. The latching arrangement of claim 7, wherein at least one of the first and second latch members includes a respective latch finger with a free end; and
wherein a corresponding at least one of the first and second catch members includes a bracket with a ramp configured to guide the free end of the respective latch finger into latching engagement with the corresponding at least one of the first and second catch members.

10. The latching arrangement of claim 9, wherein the free end of the respective latch finger of the at least one of the first and second latch members supports a rolling element configured to engage the ramp to guide the respective latch finger into latching engagement with the at least one of the first and second catch members.

11. The latching arrangement of claim 7, wherein the first latch-member location is substantially aligned with a portion of the handle; and
wherein the second latch-member location is spaced apart from the handle, along the latch rod.

12. The latching arrangement of claim 11, wherein the first latch member is disposed in a central region of the enclosure door, with respect to a vertical direction.

13. The latching arrangement of claim 7, further comprising:
a third latch member secured to the latch rod at a third latch-member location on the latch rod; and
a third catch member secured to the enclosure body at a third catch-member location on the enclosure body, the third catch member being configured to engage the third latch member to secure the enclosure door in the closed orientation;
wherein, as the handle is moved from the first handle orientation towards the second handle orientation, the first latch member engages the first catch member before the third latch member engages the third catch member.

14. The latching arrangement of claim 13, wherein, as the handle is moved from the first handle orientation towards the second handle orientation, the second and third latch members engage the second and third catch members, respectively, substantially simultaneously.

15. The latching arrangement of claim 7, wherein moving the handle from the first handle orientation towards the second handle orientation causes the latch rod to move at least partly axially, so that the first and second latch members move at least partly translationally to engage the first and second catch members, respectively.

16. The latching arrangement of claim 15, wherein a latch-member spacing between the first and second latch-member locations on the latch rod is different from a catch-member spacing between the first and second catch-member locations on the enclosure body, with the difference between the latch-member spacing and the catch-member spacing causing the first latch member to engage the first catch member before the second latch member engages the second catch member, as the handle is moved from the first handle orientation towards the second handle orientation.

17. The latching arrangement of claim 7, wherein the handle is connected to at least one of a first rack and a first rack gear, and the latch rod is connected to a second rack that engages the at least one of the first rack and the first rack gear; and
wherein moving the handle from the first handle orientation towards the second handle orientation causes the at least one of the first rack and the first rack gear to move the second rack and the latch rod.

18. A method of latching an electrical enclosure that includes an enclosure body that houses electrical components, an enclosure door configured to pivot between open and closed orientations, a handle supported by the enclosure door, a first latch member supported by the enclosure door, a second latch member supported by the enclosure door, a first catch member secured to the enclosure body, and a second catch member secured to the enclosure body, the method comprising:
moving the enclosure door from an open orientation towards a closed orientation in which the enclosure door protects the electrical components; and
moving the handle to cause the first latch member and the second latch member to translate relative to the enclosure door so that, as the handle is moved, the first latch member engages the first latch member before the second catch member engages the second latch member.

19. The method of claim 18, wherein moving the handle causes the first latch member to engage the first catch member to urge the enclosure door towards the closed orientation before the second latch member contacts the second catch member.

20. The method of claim 18, wherein moving the enclosure door includes moving at least one electrical component that is secured to the enclosure door.
